(19) United States
(12) Patent Application Publication
(10) Pub. No.: US 2012/0290949 A1
(43) Pub. Date: Nov. 15, 2012

(54) SYSTEM AND METHOD FOR FACILITATING USER INTERACTION IN A VIRTUAL SPACE THROUGH UNINTENDED TANGENTIAL EFFECTS TO PRIMARY USER INTERACTIONS

(75) Inventors: Orion ELENZIL, San Francisco, CA (US); Jeffrey Hyman, Tiburon, CA (US)

(73) Assignee: Idle Games, San Francisco, CA (US)

(21) Appl. No.: 13/103,867

(22) Filed: May 9, 2011

(51) Int. Cl. G06F 3/01; G06F 15/16

(52) U.S. Cl. 715/753

(57) ABSTRACT

User interaction within a virtual space is facilitated through unintended side effects to primary interactions between users. In the virtual space, primary interactions between source and target users have unintended tangential effects. The tangential effects are provided to other users. The other users are users which are active at the time the corresponding primary interaction was triggered, and are relatively likely to enjoy participating in the virtual space with the source and/or target users. This may encourage interaction between the users as they respond to the tangential effects (e.g., by responding to the source user of a primary interaction that caused the effects).

### FIELD OF THE INVENTION

The invention relates to facilitating interactions between users in a virtual space by providing unintended tangential effects of a primary interaction between two users to other users such that the users involved in the primary interaction and the users that receive the tangential effects of the primary interaction may be encouraged to interact in the virtual space.

### BACKGROUND OF THE INVENTION

Systems that execute instances of virtual spaces, in order to host the virtual space to users via client computing platforms are known. The systems may enable users to interact with each other and/or the virtual spaces. In existing systems, users tend to create well-defined social groups, and to eschew broadening their social circles within the virtual space. These may cause social interactions within the virtual spaces to atrophy as users become more entrenched in their social groups.

### SUMMARY

One aspect of the invention relates to a system and method for facilitating user interaction within a virtual space. In the virtual space, primary interactions between source and target users have unintended tangential effects. The tangential effects are provided to other users. The other users are users which are active at the time the corresponding primary interaction was triggered, and are relatively likely to enjoy participating in the virtual space with the source and/or target users. This may encourage interaction between the users as they respond to the tangential effects (e.g., by responding to the source user of a primary interaction that caused the effects).

The system may include a server configured to host one or more instances of the virtual space to client computing devices associated with the users. The server may be configured to execute a space module, usage monitoring module, a relationship module, a user matching module, a primary interaction module, an effect target module, a tangential effect module, and/or other modules.

The space module may be configured to execute the one or more instances of the virtual space. The space module may implement the one or more instances to determine views of the virtual space for presentation to users on client computing devices. The space module may enable users to interact with the virtual space and/or each other in the virtual space by performing actions in the one or more instances based on input of the users received from the client computing platforms.

The usage monitoring module may be configured to monitor usage of the virtual space by the users. This may include determining which users are active on the virtual space at a given time, determining an activity parameter for the users, keeping a history of past interactions in the virtual space, and/or other monitoring activities.

The relationship module may be configured to establish and/or maintain relationships between the users. The relationships may include one-to-one relationships, group relationships, and/or other relationships. The relationships may include, for example, friendships, links, guilds, raiding parties, teams, factions, and/or other relationships.

The user matching module may be configured to determine sets of two or more users likely to enjoy interacting in the virtual space together. This may include determining likelihoods that the sets of two or more users will enjoy interacting the virtual space together. These determinations may be made based on monitored usage, relationships in the virtual space, feedback received from the users, and/or other information.

The primary interaction module may be configured to trigger primary interactions in the virtual space responsive to reception of user-selected primary interaction commands. A primary interaction may be triggered responsive to reception of a corresponding user-selected primary interaction command. The primary interaction command may be received from a source user. The primary interaction command may indicate a target user at whom the primary interaction is directed, a primary interaction type of the primary interaction to be directed at the target user, and/or other parameters of the primary interaction. The other parameters may include one or more of a time or timeframe for the primary interaction, a strength of the primary interaction, and/or other parameters.

A primary interaction may include a spell cast on the target user (and/or objects or characters associated with the target user), damage or conversion of some item(s) of inventory of the target user, presentation of item(s) of inventory to the target user, interacting with the virtual space, casting powers or spells, creating or destroying terrain in the virtual space, creating or destroying virtual items in the virtual space, interacting with non-player characters in the virtual space, and/or other interactions. By way of non-limiting example, one primary interaction may involve a spell being cast on at least one character associated with the target user. The impact of the spell may be positive or negative to the target user. The impact of the spell may include a visual expression of the spell and/or its impact in the virtual space, an adjustment to one or more parameters of the character or objects, and/or other impacts. The one or more parameters adjusted by the spell may include a strength, a skill, a speed, a size, and/or other parameters.

The primary interaction module may be configured such that a triggered primary interaction is reported, expressed, or presented to the target user in a manner that identifies the source user. For example, a target user may receive a textual message indicating that the identity of the source user associated with a primary interaction experienced by the target user.

The effect target module may be configured to identify tangential effect targets of tangential effects caused in the virtual space by primary interactions. For a given primary interaction, this may involve identifying tangential effect targets for the given primary interaction responsive to reception of the primary interaction command. The effect target module may be configured such that the tangential effect targets are made up, in whole or in part, of users that are currently active in the virtual space at the time the primary interaction command is received. This may create a situation in which tangential effect targets receive the impact of the tangential effects in real-time or near real-time, which may give the tangential effect targets an opportunity to respond to, or engage with, the source target at or near the time the primary interaction command is received.

The effect target module may be configured such that the tangential effect targets are made up, in whole or in part, of users that are relatively more likely to enjoy participating in the virtual space with one or both of the source user and/or the target user. As such, the effect target module may determine the tangential effect targets for the given primary interaction based on the likelihoods determined by the user matching module. The tangential effect targets may include, in whole or in part, one or more of the following: users previously unknown to the source and/or target user, users that have not interacted with the source and/or target user for some threshold period of time, with which the source and/or target user interact regularly, and/or other users.

The tangential effect module may be configured to trigger tangential effects of primary interactions in the virtual space. The tangential effect module is configured such that responsive to reception of the first primary interaction command, tangential effects are triggered in the virtual space that directly impact the first tangential effect targets.

The tangential effect module may be configured to trigger, responsive to a primary interaction command, the tangential effects associated with the primary interaction. The triggered tangential effects may be provided to the tangential effect targets determined by the effect target module for the primary interaction. The tangential effect module may be configured such that triggering the tangential effects may include providing a notification to the tangential effect targets of the source and/or target user of the associated primary interaction. This notification may include a mechanism by which the tangential effect targets can respond to the tangential effects received. Such response may include an invitation (e.g., to participate in an interaction, to a relationship, and/or other invitations), a message, a primary interaction, and/or other responses. The notification may include, for example, text indicating the identity of the source and/or target users.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate interactions between users in a virtual space.

FIG. 2 illustrates tangential effects associated with a primary interaction between two users in a virtual space.

FIG. 3 illustrates a method of facilitating interactions between users in a virtual space.

### DETAILED DESCRIPTION

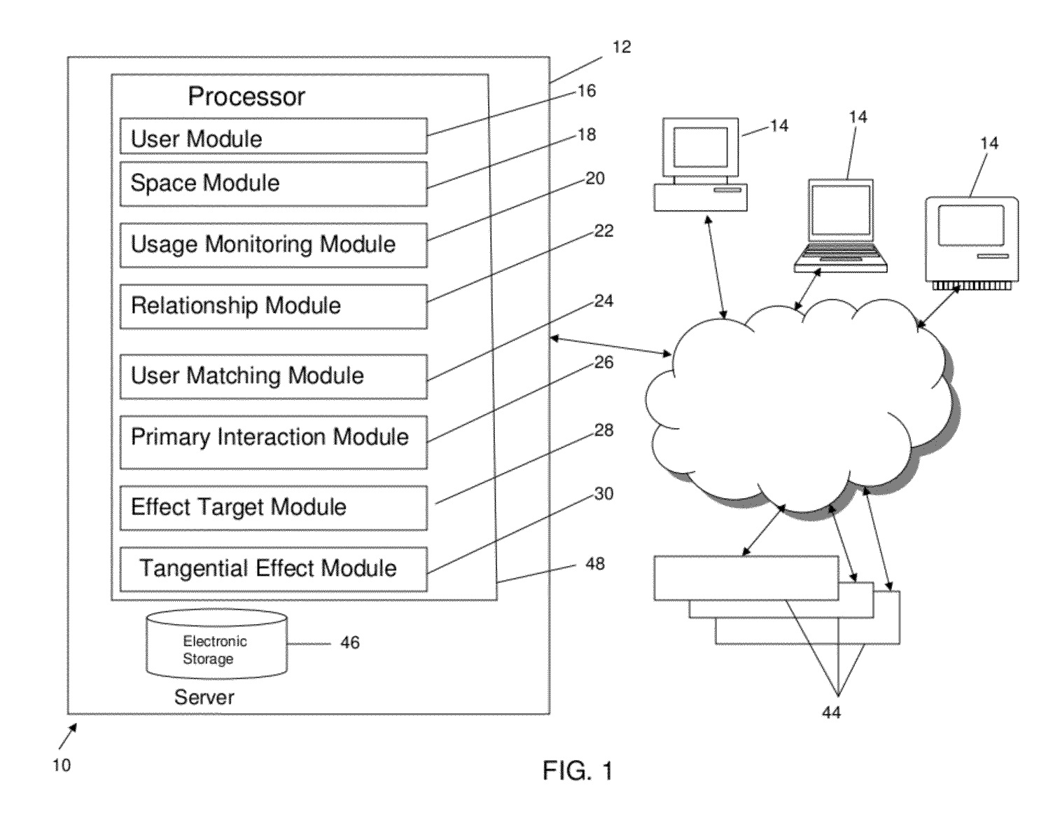

FIG. 1 illustrates a system 10 configured to provide a virtual space to users. The virtual space may be a space in which a game is played, in which users communicate with each other, and/or in which other activities are conducted. Providing the virtual space may include hosting the virtual space over a network. In some implementations, system 10 may include a server 12. The server 12 may be configured to communicate with one or more client computing platforms 14 according to a client/server architecture. The users may access system 10 and/or the virtual space via client computing platforms 14.

The server 12 may be configured to execute one or more computer program modules. The computer program modules may include one or more of a user module 16, a space module 18, a usage monitoring module 20, a relationship module 22, a user matching module 24, a primary interaction module 26, an effect target module 28, a tangential effect module 30, and/or other modules.

The user module 16 may be configured to access and/or manage one or more user profiles and/or user information associated with users of the system 10. The one or more user profiles and/or user information may include information stored by server 12, one or more of the client computing platforms 14, and/or other storage locations. The user profiles may include, for example, information identifying users (e.g., a username or handle, a number, an identifier, and/or other identifying information) within the virtual space, security login information (e.g., a login code or password), virtual space account information, subscription information, virtual currency account information (e.g., related to currency held in credit for a user), relationship information (e.g., information related to relationships between users in the virtual space), virtual space usage information, demographic information associated with users, interaction history among users in the virtual space, information stated by users, purchase information of users, browsing history of users, a client computing platform identification associated with a user, a phone number associated with a user, and/or other information related to users.

The space module 18 may be configured to execute one or more instances of the virtual space. The virtual space may include separate spatial areas within the virtual space. The space module 18 may be configured to implement the instance(s) of the virtual space to determine views of the virtual space. The views may then be communicated (e.g., via streaming, via object/position data, and/or other information) from server 12 to client computing platforms 14 for presentation to users. The view determined and transmitted to a given client computing platform 14 may correspond to a user character being controlled by a user via the given client computing platform 14. The view determined and transmitted to a given client computing platform 14 may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user

The virtual space may comprise a simulated space (e.g., similar to a physical space) that is accessible by users via clients (e.g., client computing platforms 14) that present the views of the virtual space to users. The virtual space may be divided into separate places, which may be depicted as separate islands, rooms, neighborhoods, cities, arenas or stadiums, and/or other places. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the destination node, and/or surface features of a surface or objects that are “native” to the destination node. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein).

The above description of the manner in which views of the virtual space are determined by space module 18 is not intended to be limiting. The space module 18 may be configured to express the virtual space in a more limited, or more rich, manner. For example, views determined for the virtual space may be selected from a limited set of graphics depicting an event in a given place in the virtual space. The views may include additional content (e.g., text, audio, pre-stored video content, and/or other content) that describes particulars of the current state of the given place, beyond the relatively generic graphics. For example, a view may include a generic battle graphic with a textual description of the opponents to be confronted. Other expressions of the virtual space are contemplated.

The instances executed by space module 18 may be synchronous or asynchronous. A synchronous instance of the virtual space may facilitate a first user witnessing, in the views presented to the first user, interactions of other users with the same instance of the virtual space. This may include, for example, watching in real time (or near real time) an avatar, or other object, under the control of another user move through the virtual space. An asynchronous instance of the virtual space may be executed for viewing by an individual user. As such, the asynchronous instance of the virtual space may not be configured to express interactions with the virtual space by two users concurrently in real time or near real time. It will be appreciated that an asynchronous instance of the virtual space may not preclude users from communicating via, for example, chat, private message, and/or voice chat through server 12. Instead, since simultaneous interactions with the virtual space by two different users may not be expressed within the asynchronous instance, a user presented with views of the virtual space generated from the asynchronous instance may not be able to see avatars, or other objects, under direct control of other users in views of the asynchronous instance of the virtual space.

Within the virtual space instanced by space module 18, users may control characters, objects, simulated physical phenomena (e.g., wind, rain, earthquakes, and/or other phenomena), and/or other elements within the places to interact with the places and/or each other. The user characters may include avatars. As used herein, the term “user character” may refer to an object (or group of objects) present in the virtual space that represents an individual user. The user character may be controlled by the user with which it is associated. The user controlled element(s) may move through and interact with the virtual space (e.g., non-user characters in the virtual space, other objects in the virtual space). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual space.

The users may participate in the virtual space by controlling one or more of the available user controlled elements in the places. Control may be exercised through control inputs and/or commands input by the users through client computing platforms 14. The users may interact with each other through communications exchanged within the virtual space. Such communications may include one or more of textual chat, instant messages, private messages, voice communications, and/or other communications. Communications may be received and entered by the users via their respective client computing platforms 14. Communications may be routed to and from the appropriate users through server 12 (e.g., through space module 18).

The usage monitoring module 20 may be configured to monitor interactions of the users with the virtual space and/or each other within the virtual space. This may include monitoring, for a given user, one or more of times at which the given user is logged in to the virtual space, areas of the virtual space the given user views or interacts with or in, other users the given user interacts with, the nature and/or content of interactions of the given user with other users, activities participated in within the virtual space, level, powers, or skill attained in the virtual space, inventory items obtained in the virtual space, and/or other interactions of the given user with the virtual space and/or other users. Some or all of the information generated by usage monitoring module 20 in monitoring the interactions of the users may be stored to the user profiles managed by user module 16.

At a given time, usage monitoring module 20 may determine a set of users that are currently active in the virtual space and/or a set of users that are currently not active in the virtual space. Being active in the virtual space may refer to being logged in to the virtual space, performing some action or interaction within the virtual space within some period of time (e.g., the last 2 minutes), and/or other taking some other action indicating ongoing and contemporaneous engagement with the virtual space.

The usage monitoring module 20 may be configured to determine, for individual users, an activity metric that indicates an activity level within the virtual space. The activity metric may be determined based on one or more of log in frequency, amount of time logged in to the virtual space within a rolling time period (e.g., over the last day, week, month, or other rolling time period), average amount of time logged in to the virtual space over some length of time (e.g., per day, per week, and/or other length of time), average log in session time over a rolling time period, number of inter-user communications over a length of time, number of inter-user communications per log in, number of relationships with other users in the virtual space, number of new relationships with other users in the virtual space within a rolling time period, style of gameplay (e.g., aggressive, cooperative, defensive, risk-taking, risk-averse, and/or other styles), spending patterns, character and/or player inventory, player and/or character level, account age, and/or other activity parameters.

The relationship module 22 may be configured to establish relationships between users within the virtual space. Such relationships may include one or more of friendships, guilds (with guild-mates), alliances, connections, and/or other relationships. The relationship module 22 may establish relationships based on relationship requests and acceptances received from users. Establishment of a relationship may be initiated by a single communication (e.g., a request) initiated by a given user requesting a relationship between the given user and one or more other users. Establishment of a relationship may require a first communication from the given user to be approved by the one or more other users. The relationship module may be configured to identify and/or establish relationships based on interactions between users. For example, reciprocation or cooperation in one or more interactions or activities may give rise to establishment of a relationship between users. Activities that may give rise to establishment of a relationship between users may include one or more of visiting (and/or accepting visits) between users within the virtual space, searching for another player (e.g., using a search portal provided by the relationship module), sending messages, items, or other communications to another user within the virtual space, and/or other activities. Such relationships may include friendships, guilds (with guild-mates), alliances, connections, and/or other relationships. Relationships may include one or more types of relationships that have a functional purpose or impact within the virtual space. Relationships may include one or more types of relationships that are merely a social construct within the virtual space and do not have a functional result or purpose.

The relationship module 22 may be configured to parameterize the strength of established relationships. This may include determining a strength metric that quantifies a strength of a relationship between two or more users. The strength metric may increase when one user reciprocates action from another. Such action may include, for example, sending a message, visiting an area or character associated with another user, sending a gift (e.g., virtual good(s), virtual currency, and/or other gifts), casting a power or spell on an area or character associated with another user, and/or other actions. In determining the strength metric, relationship module 22 may weight some actions more significantly than others. This weighting may depend, for example, on an amount of value (e.g., time, effort, virtual currency, virtual good, and/or other value) expended by a user in the action. In determining the strength metric, relationship module 22 may weight actions based on time. For example, a first action by a first user toward a second user that reciprocates a second action by the second user toward the first user may be afforded greater weight the closer the first action is in time to the second action. The relationship module 22 may be configured such that strength metric (and/or the weight afforded to actions upon which the strength metric is based) decay over time. As such, if a strong relationship exists between the first user and the second user at a first point in time, the strength metric will become lower and lower over time if the first user and the second user do not continue to participate and/or interact in the virtual space with each other.

The user matching module 24 may be configured to determine likelihoods that specific sets of two or more users will enjoy interacting with each other in the virtual space. This may include determining one or more metrics indicating such likelihoods. The user matching module 24 may be configured such that a likelihood determined for a set of users may be interaction-type specific. The interaction-type may include one or more of participating in quests together, participating in a guild together, participating in an exchange of virtual goods and/or currency, participating in inter-user communications within the virtual space, playing a game against each other, cooperating to enhance each others stamina, score, manna, virtual currency, skill level, and/or other parameters, interacting with the virtual space, casting powers or spells, creating or destroying terrain in the virtual space, creating or destroying virtual items, interacting with non-player characters in the virtual space, and/or other interactions.

To determine the likelihoods, user matching module 24 may use as inputs the usage and/or interactions monitored by usage monitoring module 20. For example, determinations by user matching module 24 may reflect that a set of users that consistently participate in the same types of interactions, and/or perform the same types of interactions in the same or similar manners would likely enjoy participating in such interactions with one another. This may include determining the likelihoods based on, for example, style of gameplay (e.g., aggressive, cooperative, defensive, risk-taking, risk-averse, and/other styles), spending patterns, types of related players, player and/or character inventory, player and/or character level, and/or other game, player, or character characteristics or activities. As another non-limiting example, determinations by user matching module 24 may reflect temporal usage patterns of the set of users such that users having corresponding or complimentary temporal usage patterns may be more likely to enjoy participating in interactions with each other in the virtual space. The temporal usage pattern of a user may include a frequency of log-ins, a frequency of interactions in the virtual space, a length (or average length) of interactions, a pattern of timings of interactions participated in by the user (e.g., typical times of day, days of the week, and/or other patterns), account age, and/or temporal parameters of virtual space usage. The user matching module 24 may implement the interactions and/or usage monitored by usage monitoring module 20 in other ways.

To determine the likelihoods, user matching module 24 may use as inputs relationships between users established by relationship module 22. For example, determinations by user matching module 24 may reflect that users that have established relationships may enjoy participating in interactions with each other in the virtual space. As another non-limiting example, determinations by user matching module 24 may reflect that a set of users having established relationships with another user in common (e.g., a first and second user each having an established relationship with a third user) may enjoy participating in interactions with each other in the virtual space. The user matching module 24 may implement the relationships established by relationship module 22 in other ways.

In some implementations, user matching module 24 may be configured to receive feedback from users on the likelihoods determined by user matching module 24. This may come in the form of selected or entered ratings (e.g., on a scale). The ratings may indicate the accuracy with which user matching module 24 has determined sets of users that enjoy participating in interactions together in the virtual space. The user matching module 24 may be configured to implement such ratings in further determinations of likelihoods that other sets of users will enjoy participating in interactions together within the virtual space. Other inputs may be used by user matching module 24 in determining the likelihoods and/or metrics.

The primary interaction module 26 may be configured to trigger primary interactions in the virtual space. A primary interaction may be triggered responsive to reception of a corresponding user-selected primary interaction command. The primary interaction command may be received from a source user. The primary interaction command may indicate a target user at whom the primary interaction is directed, a primary interaction type of the primary interaction to be directed at the target user, and/or other parameters of the primary interaction. The other parameters may include one or more of a time or timeframe for the primary interaction, a strength of the primary interaction, and/or other parameters. Triggering the primary interaction in the virtual space may result in the primary interaction being delivered to the target user in one or more instances of the virtual space maintained by space module 18.

Reception of a primary interaction command may require that the target user be currently active in the virtual space. Primary interactions with this requirement may be “synchronous” interactions. Reception of the primary interaction command may not require that the target user be currently active in the virtual space. This primary interactions may be referred to as “asynchronous” interactions. Asynchronous interactions may be triggered while the target user is not active in the virtual space. These interactions may have an impact that will be apparent to the target user the next time the target user becomes active in the virtual space. Asynchronous interactions may delay triggering after reception of a primary interaction command until the target user (and/or the source user) is active in the virtual space.

A primary interaction may include a spell cast on the target user (and/or objects or characters associated with the target user), damage or conversion of some item(s) of inventory of the target user, presentation of item(s) of inventory to the target user, moving or destroying some item(s) of inventory of the target user, damaging, converting, and/or relocating a character associated with the target user, and/or other interactions. By way of non-limiting example, one primary interaction may involve a spell being cast on at least one character associated with the target user. The impact of the spell may be positive or negative to the target user. The impact of the spell may include a visual expression of the spell and/or its impact in the virtual space, an adjustment to one or more parameters of the character or objects, and/or other impacts. The one or more parameters adjusted by the spell may include a strength, a skill, a speed, a size, and/or other parameters.

The primary interaction module 26 may be configured such that a triggered primary interaction is reported, expressed, or presented to the target user in a manner that identifies the source user. For example, a target user may receive a textual message indicating that the identity of the source user associated with a primary interaction experienced by the target user.

In the virtual space, primary interactions may not only impact targets specified in primary interaction commands. Primary interactions may also give rise to tangential effects that impact users other than the source user and the target user. The tangential effects associated with a given primary interaction may have impacts that are relatively less consequential than the primary interaction itself. Users that experience the tangential effects in the virtual space may be referred to as the tangential effects targets. A user may be said to have experienced a tangential effect if a character or object associated with the user is impacted directly by the tangential effect. By way of non-limiting example, if a primary interaction involves a spell in which a character or object associated with the target user experiences a typhoon, the tangential effects may be expressed to tangential effect targets as an increase in rain that helps crops, the appearance of provisions or characters set adrift by the typhoon, and/or other effects associated with a typhoon. As another example, a primary interaction results in a character or object associated with the target user being removed from a place in the virtual space associated with the target user (e.g., a character being “flicked” off of an island). The character or object may be transferred to (or “land on”) a place associated with a tangential effect target. The user that associated with the landing place may be granted possession of the displaced character or object.

As is described herein, the manner in which tangential effects are distributed may seem random or stochastic to users, but may have a determinative aspect which may be intended to enhance interactions between users. For example, tangential effects may be used to place users in contact that are more likely to enjoy participating in the virtual space together. As such, tangential effects may be used as icebreakers that enhance user engagement with the virtual space and/or each other.

The effect target module 28 may be configured to identify tangential effect targets for individual primary interactions. For a given primary interaction, this may involve identifying tangential effect targets for the given primary interaction responsive to reception of the primary interaction command. The given primary interaction may be associated with a predetermined number of tangential effect targets, a number of tangential effect targets determined as a function of some parameter of the primary interaction, and/or other mechanisms for determining a number of tangential effect targets. The number of tangential effect targets for the given primary interaction may be determined stochastically. The effect target module 28 may be configured such that the tangential effect targets are made up, in whole or in part, of users that are currently active in the virtual space at the time the primary interaction command is received. This may create a situation in which tangential effect targets receive the impact of the tangential effects in real-time or near real-time, which may give the tangential effect targets an opportunity to respond to, or engage with, the source target at or near the time the primary interaction command is received.

The effect target module 28 may be configured that the tangential effect targets are made up, in whole or in part, of users that are relatively more likely to enjoy participating in the virtual space with one or both of the source user and/or the target user. As such, effect target module 28 may determine the tangential effect targets for the given primary interaction based on the likelihoods determined by user matching module 24. In particular, the determination of the tangential effect targets may be based on the likelihoods determined by user matching module 24 for users with respect to the source user and/or the target user. The tangential effect targets may include, in whole or in part, one or more of the following: users previously unknown to the source and/or target user, users that have not interacted with the source and/or target user for some threshold period of time, with which the source and/or target user interact regularly, and/or other users.

Determining the set of tangential effect targets to include users that are relatively more likely to enjoy participating in the virtual space with the source user and/or the target user may provide enhancements over virtual spaces in which unintended or ancillary effects of an action from one user to another occur without regard for stimulating interactions between compatible users. For example, the tangential effects may provide a jumping off point for communication or other interaction between compatible users that may not have occurred without the tangential effects. If the tangential effects are not distributed to users likely to enjoy interacting with the source or target user, the impact of the tangential effect may be wasted from a social standpoint.

The tangential effect module 30 may be configured to trigger tangential effects of primary interactions in the virtual space. As such, responsive to a primary interaction command, tangential effect module 30 may be configured to trigger the tangential effects associated with the primary interaction. The triggered tangential effects may be provided to the tangential effect targets determined by effect target module 28 for the primary interaction. These users may include users that are active in the virtual space, and that are relatively likely to participate in interactions in the virtual space with the source and/or target user of the primary interaction. The tangential effect module 30 may be configured such that triggering the tangential effects may include providing a notification to the tangential effect targets of the source and/or target user of the associated primary interaction. This notification may include a mechanism by which the tangential effect targets can respond to the tangential effects received. Such response may include an invitation (e.g., to participate in an interaction, to a relationship, and/or other invitations), a message, a primary interaction, and/or other responses. The notification may include, for example, text indicating the identity of the source and/or target users.

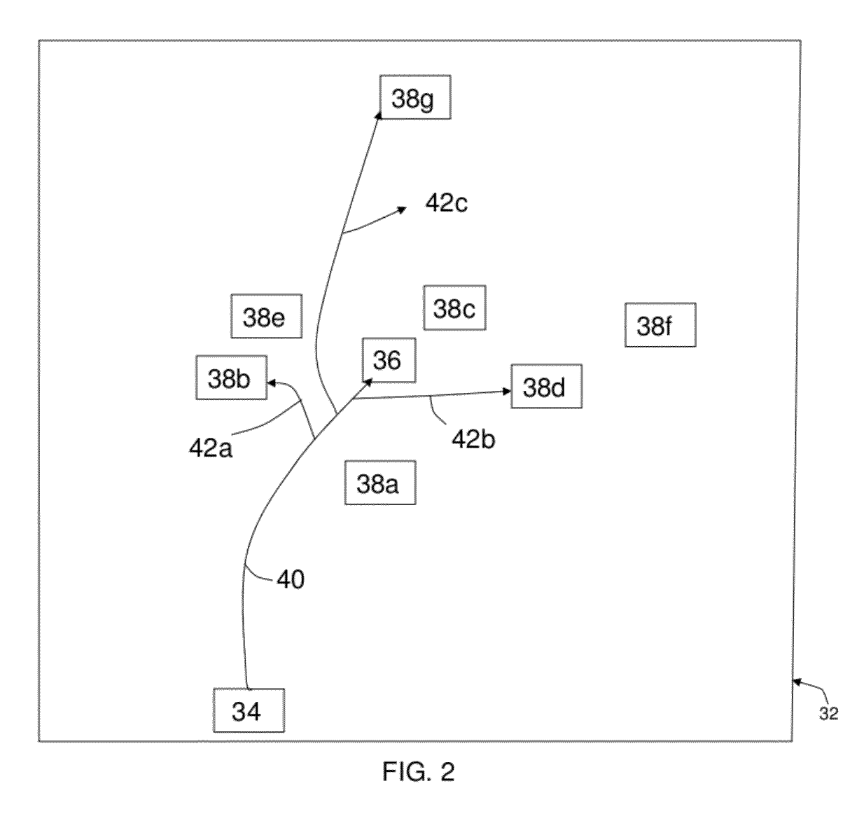

By way of illustration, FIG. 2 may depict a top down view of a virtual space 32. The virtual space 32 may include a source object 34, a target object 36, other user objects 38a-38g, and/or other objects. The source object 34 may be associated with a source user of a primary interaction. The target object 36 may be associated with a target user of the primary interaction. The other user objects 38a-38g may be associated with other users. An arrow 40 may represent the primary interaction between source object 34 and target object 36, with target object 36 receiving the impact of the primary interaction. A set of arrows 42a-42c may represent tangential effects of the primary interaction. As discussed herein, the target user may be a user selected by the source user for the primary interaction. The tangential effect targets (associated with 38b, 38d, and 38g, respectively) may not have been selected by the source user. These users may have been selected for being active in the virtual space 32 at the time of the primary interaction, and for having relatively high likelihoods of enjoying participating in virtual space 32 with the source user and/or the target user.

It will be appreciated that the illustration and/or description of the primary interaction as being associated with a single source and/or target user is not intended to be limiting. The source and/or target users associated with the primary interaction may be more than one. For example, the primary interaction may be targeted to two or more users, and/or the primary interact may originate from two or more users.

Turning back to FIG. 1, the server 12, client computing platforms 14, and/or external resources 44 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, client computing platforms 14, and/or external resources 44 may be operatively linked via some other communication media.

A given client computing platform 14 may include one or more processors configured to execute computer program modules. The computer program modules may be configured to enable an expert or user associated with the given client computing platform 14 to interface with system 10 and/or external resources 44, and/or provide other functionality attributed herein to client computing platforms 14. By way of non-limiting example, the given client computing platform 14 may include one or more of a desktop computer, a laptop computer, a handheld computer, a NetBook, a Smartphone, a gaming console, and/or other computing platforms.

The external resources 44 may include sources of information, hosts and/or providers of virtual environments outside of system 10, external entities participating with system 10, and/or other resources. In some implementations, some or all of the functionality attributed herein to external resources 44 may be provided by resources included in system 10.

The server 12 may include electronic storage 46, one or more processors 48, and/or other components. The server 12 may include communication lines, or ports to enable the exchange of information with a network and/or other computing platforms. Illustration of server 12 in FIG. 1 is not intended to be limiting. The server 12 may include a plurality of hardware, software, and/or firmware components operating together to provide the functionality attributed herein to server 12. For example, server 12 may be implemented by a cloud of computing platforms operating together as server 12.

Electronic storage 46 may comprise electronic storage media that stores information. The electronic storage media of electronic storage 46 may include one or both of system storage that is provided integrally (i.e., substantially non-removable) with server 12 and/or removable storage that is removably connectable to server 12 via, for example, a port (e.g., a USB port, a firewire port, etc.) or a drive (e.g., a disk drive, etc.). Electronic storage 46 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 46 may include one or more virtual storage resources (e.g., cloud storage, a virtual private network, and/or other virtual storage resources). Electronic storage 46 may store software algorithms, information determined by processor 48, information received from server 12, information received from client computing platforms 14, and/or other information that enables server 12 to function properly.

Processor(s) 48 is configured to provide information processing capabilities in server 12. As such, processor 48 may include one or more of a digital processor, an analog processor, a digital circuit designed to process information, an analog circuit designed to process information, a state machine, and/or other mechanisms for electronically processing information. Although processor 48 is shown in FIG. 1 as a single entity, this is for illustrative purposes only. In some implementations, processor 48 may include a plurality of processing units. These processing units may be physically located within the same device, or processor 48 may represent processing functionality of a plurality of devices operating in coordination. The processor 48 may be configured to execute modules 16, 18, 20, 22, 24, 26, 28, and/or 30. Processor 48 may be configured to execute modules 16, 18, 20, 22, 24, 26, 28, and/or 30 by software; hardware; firmware; some combination of software, hardware, and/or firmware; and/or other mechanisms for configuring processing capabilities on processor 48.

It should be appreciated that although modules 16, 18, 20, 22, 24, 26, 28, and/or 30 are illustrated in FIG. 1 as being co-located within a single processing unit, in implementations in which processor 48 includes multiple processing units, one or more of modules 16, 18, 20, 22, 24, 26, 28, and/or 30 may be located remotely from the other modules. The description of the functionality provided by the different modules 16, 18, 20, 22, 24, 26, 28, and/or 30 described below is for illustrative purposes, and is not intended to be limiting, as any of modules 16, 18, 20, 22, 24, 26, 28, and/or 30 may provide more or less functionality than is described. For example, one or more of modules 16, 18, 20, 22, 24, 26, 28, and/or 30 may be eliminated, and some or all of its functionality may be provided by other ones of modules 16, 18, 20, 22, 24, 26, 28, and/or 30. As another example, processor 48 may be configured to execute one or more additional modules that may perform some or all of the functionality attributed below to one of modules 16, 18, 20, 22, 24, 26, 28, and/or 30.

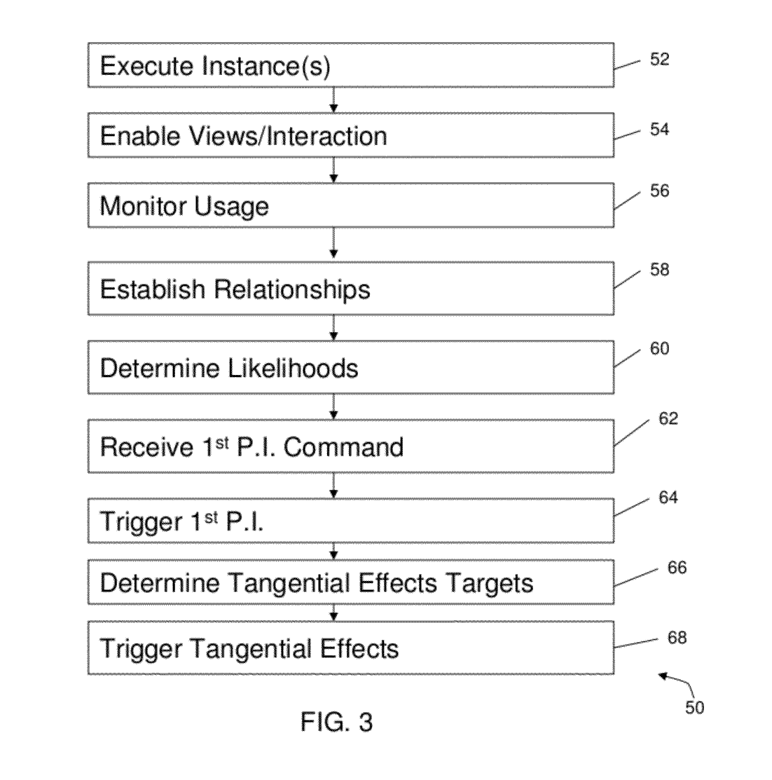

FIG. 3 illustrates a method 50 of facilitating user interactions within a virtual space. The operations of method 50 presented below are intended to be illustrative. In some embodiments, method 50 may be accomplished with one or more additional operations not described, and/or without one or more of the operations discussed. Additionally, the order in which the operations of method 50 are illustrated in FIG. 3 and described below is not intended to be limiting.

In some embodiments, method 50 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 50 in response to instructions stored electronically on an electronic storage medium. The one or more processing devices may include one or more devices configured through hardware, firmware, and/or software to be specifically designed for execution of one or more of the operations of method 50.

At an operation 52, one or more instances of a virtual space may be executed. In some implementations, operation 52 may be performed by a space module similar to or the same as space module 18 (shown in FIG. 1 and described herein).

At an operation 54, the one or more instances may be implemented to determine views of the virtual space for presentation to users on client computing devices, and to enable users to interact with the virtual space and/or each other in the virtual space. Users may be enabled to interact with the virtual space and/or each other by performing actions in the one or more instances based on input of the users received from the client computing platforms. In some implementations, operation 54 may be performed by a space module similar to or the same as space module 18 (shown in FIG. 1 and described herein).

At an operation 56, usage of users of the instances of the virtual space may be monitored. Such monitoring may include determining which users are active on the virtual space, determination of an activity metric for users, monitoring usage patterns of individual users, and/or other monitoring. For a given user, such monitoring may include monitoring one or more of times at which the given user is logged in to the virtual space, areas of the virtual space the given user views or interacts with or in, other users the given user interacts with, the nature and/or content of interactions of the given user with other users, activities participated in within the virtual space, level, powers, or skill attained in the virtual space, inventory items obtained in the virtual space, and/or other interactions of the given user with the virtual space and/or other users. In some implementations, operation 56 may be performed by a usage monitoring module similar to or the same as usage monitoring module 20 (shown in FIG. 1 and described herein).

At an operation 58, relationships between two or more users in the virtual space may be established and/or maintained. In some implementations, operation 58 may be performed by a relationship module similar to or the same as relationship module 22 (shown in FIG. 1 and described herein).

At an operation 60, likelihoods that two or more users will enjoy participating in interactions in the virtual space together may be determined. The likelihoods may be determined based on monitoring performed at operation 56, relationships established at operation 58, explicit feedback regarding other users received from the users, and/or other information. In some implementations, operation 60 may be performed by a user matching module similar to or the same as user matching module 24.

At an operation 62, a first primary interaction command may be received from a source user. The first primary interaction command may indicate a target user, a type of primary interaction, one or more parameters of the primary interaction, and/or other information. In some implementations, operation 62 may be performed by a primary interaction module similar to or the same as primary interaction module 26 (shown in FIG. 1 and described herein).

At an operation 64, responsive to reception of the first primary interaction command, a first primary interaction between the source user and the target user in the virtual space may be triggered. Triggering of the first primary interaction may result in the first primary interaction being provided to the target user (e.g., to an object or character associated with the target user) in the virtual space. The target user may receive an indication of the identity of the source user. In some implementations, operation 64 may be performed by a primary interaction module similar to or the same as primary interaction module 26 (shown in FIG. 1 and described herein).

At an operation 66, responsive to reception of the first primary interaction command, a subset of the other users currently active in the virtual space may be identified as first tangential effect targets of tangential effects caused in the virtual space by the first primary interaction. The first tangential effect targets may be identified based on usage monitored at operation 56, relationships established at operation 58, likelihoods the first tangential effect targets will enjoy participating in the virtual space with the source user and/or the target user determined at operation 60, and/or other parameters. In some implementations, operation 66 may be performed by an effect target module similar to or the same as effect target module 28 (shown in FIG. 1 and described herein).

At an operation 68, responsive to reception of the first primary interaction command, tangential effects in the virtual space that directly impact the first tangential effect targets may be triggered. Triggering of the tangential effects may result in the impact of the tangential effects being provided to characters and/or objects associated with the tangential effect targets in the virtual space. The tangential effect targets may receive notification of the source user and/or the target user associated with the first primary interaction. The notification may include a mechanism for responding to the received tangential effects. In some implementations, operation 68 may be performed by a tangential effect module similar to or the same as tangential effect module 30 (shown in FIG. 1 and described herein).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to facilitate user interactions within a virtual space provided to users via client computing platforms, the system comprising:
one or more servers configured to execute computer program modules, the computer program modules comprising:
a space module configured to execute one or more instances of a virtual space, and to implement the one or more instances to determine views of the virtual space for presentation to users on client computing devices, and to enable users to interact with the virtual space and each other in the virtual space by performing actions in the one or more instances based on input of the users received from the client computing platforms;
a primary interaction module configured to trigger primary interactions in the instance responsive to reception of user-selected primary interaction commands, wherein the primary interaction module is configured such that, responsive to reception of a first primary interaction command from a source user, a first primary interaction between the source user and a target user indicated in the first primary interaction command is triggered in the virtual space;
an effect target module configured to identify tangential effect targets of tangential effects caused in the virtual space by primary interactions, wherein the tangential effect module is configured such that, responsive to reception of the first primary interaction command, a subset of the other users currently active in the virtual space are identified as first tangential effect targets; and
a tangential effect module configured to trigger tangential effects of primary interactions in the virtual space, wherein the tangential effect module is configured such that responsive to reception of the first primary interaction command, tangential effects are triggered in the virtual space that directly impact the first tangential effect targets.

2. The system of claim 1, wherein the computer program modules are configured such that the first tangential effect targets are the only users in the virtual space that are impacted by the tangential effects associated with the first primary interaction.

3. The system of claim 1, wherein the computer program modules are configured such that the target user is not active in the virtual space at the time the first primary interaction is triggered.

4. The system of claim 1, wherein the tangential effects module is configured such that, responsive to the tangential effects being triggered for the first tangential effects targets, the first tangential effects targets receive notification in the virtual space of one or both of the source user and/or the target user associated with the first primary interaction.

5. The system of claim 1, wherein the computer program modules further comprise a user matching module configured to determine likelihoods that specific sets of two or more users will enjoy participating together in interactions in the virtual space, and wherein the effect target module is configured such that the first tangential effect targets are identified based on the likelihoods determined by the user matching module.

6. The system of claim 5, wherein the effect target module is configured such that the first tangential effect targets are made up of other users having relatively high likelihoods of enjoying participating in interactions in the virtual space with one or both of the source user and/or the target user of the primary interaction.

7. The system of claim 1, wherein the effect target module is configured such that the first tangential effect targets are identified based on one or both of usage patterns and/or relationships of the users in the virtual space.

8. The system of claim 1, wherein the effect target module is configured such that the identification of the first tangential effect targets is in part stochastic.

9. The system of claim 1, wherein the tangential effects module is configured such that the tangential effects associated with the first primary interaction are triggered substantially contemporaneously with the triggering of the first primary interaction.

10. A method of facilitating user interactions within a virtual space provided to users via client computing platforms, the method comprising:
executing one or more instances of a virtual space;
implementing the one or more instances to determine views of the virtual space for presentation to users on client computing devices, and to enable users to interact with the virtual space and each other in the virtual space by performing actions in the one or more instances based on input of the users received from the client computing platforms;
receiving a first primary interaction command from a source user, the first primary interaction command indicating a target user;
responsive to reception of the first primary interaction command, triggering a first primary interaction between the source user and the target user in the virtual space;
responsive to reception of the first primary interaction command, identifying a subset of the other users currently active in the virtual space as first tangential effect targets of tangential effects caused in the virtual space by the first primary interaction; and
responsive to reception of the first primary interaction command, triggering tangential effects in the virtual space that directly impact the first tangential effect targets.

11. The method of claim 10, wherein the first tangential effect targets are the only users in the virtual space that are impacted by the tangential effects associated with the first primary interaction.

12. The method of claim 10, wherein the target user is not active in the virtual space at the time the first primary interaction command is received, and is not active in the virtual space at the time the first primary interaction command is triggered.

13. The system of claim 10, further comprising, responsive to the triggering of the tangential effects associated with the first primary interaction, notice to the first tangential effect targets in the virtual space of the identity of one or both of the source user and/or the target user associated with the first primary interaction.

14. The method of claim 10, further comprising determining likelihoods that specific sets of two or more users will enjoy participating together in interactions in the virtual space, and wherein the first tangential effect targets are identified based on the determined likelihoods.

15. The method of claim 14, wherein the first tangential effect targets are made up of other users having relatively high likelihoods of enjoying participating in interactions in the virtual space with one or both of the source user and/or the target user.

16. The method of claim 10, wherein the first tangential effect targets are identified based on one or both of usage patterns and/or relationships of the users in the virtual space.

17. The method of claim 10, wherein the identification of the first tangential effect targets is in part stochastic.

18. The method of claim 10, wherein the tangential effects associated with the first primary interaction are triggered substantially contemporaneously with the triggering of the first primary interaction.
